(19) United States
(12) Patent Application Publication
(10) Pub. No.: US 2007/0184322 A1
(43) Pub. Date: Aug. 9, 2007

(54) Membrane electrode assembly in solid oxide fuel cells

(76) Inventors: Hong Huang, Palo Alto, CA (US); Pei-Chen Su, Stanford, CA (US); Friedrich B. Prinz, Woodside, CA (US); Masafumi Nakamura, Tokyo (JP); Timothy P. Holme, Stanford, CA (US); Rainer J. Fasching, Mill Valley, CA (US); Yuji Saito, Tokyo (JP)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/655,460

(22) Filed: Jan. 18, 2007

Related U.S. Application Data
(63) Continuation-in-part of application No. 11/169,848, filed on Jun. 28, 2005.
(63) Continuation-in-part of application No. 11/171,112, filed on Jun. 29, 2005.
(60) Provisional application No. 60/584,767, filed on Jun. 30, 2004.
(60) Provisional application No. 60/584,767, filed on Jun. 30, 2004.
(60) Provisional application No. 60/760,998, filed on Jan. 19, 2006.
(60) Provisional application No. 60/850,170, filed on Oct. 5, 2006.

(51) Int. Cl. H01M 8/12; H01M 8/02; B05D 5/12

(52) U.S. Cl. 429/32; 429/34; 427/115

(57) ABSTRACT

A membrane-electrode assembly for a solid oxide fuel cell is provided. The membrane-electrode assembly has a substantially constant-thickness electrolyte layer. The electrolyte layer distinguishes first and second electrolyte layer surfaces arranged in a three-dimensional pattern with opposite first and second planar pattern surfaces. The three-dimensional pattern has a first set of features extending inward from the first planar pattern surface. It has a second set of features extending inward from the second planar pattern surface opposite to the first planar pattern surface. A first electrode layer is adjacent and conforming to the first electrolyte layer surface. At least one mechanical support structure exists within some or all of the second set of features. A second electrode layer is adjacent and conforming to the second electrolyte layer surface and to at least one mechanical support structure. The membrane-electrode assembly is deposited on a substrate with at least one through hole.

### CROSS-REFERENCE TO RELATED APPLICATIONS

This application is a continuation-in-part of U.S. patent applications Ser. No. 11/169,848 filed Jun. 28, 2005 and Ser. No. 11/171,112 filed Jun. 29, 2005, whereby both U.S. Patent Applications claim the benefit from U.S. Provisional Patent Application 60/584,767 filed Jun. 30, 2004. This application is cross-referenced to and claims the benefit from U.S. Provisional Patent Applications 60/760,998 filed Jan. 19, 2006, and 60/850,170 filed Oct. 5, 2006. All referenced applications are hereby incorporated by reference.

### FIELD OF THE INVENTION

The invention relates generally to solid oxide fuel cells. More particularly, the invention relates to thin films for solid oxide fuel cells.

### BACKGROUND

Solid oxide fuel cell (SOFC) is a type of fuel cell where solid oxide is used as an electrolyte and oxygen ions can pass through. The operation principle of an SOFC involves reduction of oxygen gas at positive electrode (usually called cathode), oxygen ion transport through the electrolyte membrane, oxidation of the fuel gas, e.g. hydrogen at the negative electrode (usually referred to as anode). Typical electrolyte includes stabilized zirconia and doped ceria, like yttria stabilized zirconia (YSZ) and gadolinia doped ceria (GDC). Typical electrodes can be metal catalyst, like Pt, Ag, Ni, mixed ionic and electronic conducting oxides, as well as catalyst/electrolyte composites.

Due to the limited properties of the prior mentioned materials, for example, low ionic conductivity and low catalytic activity, SOFC needs to be operated at fairly high temperature in excess of 700 degrees Celsius.

The maximum power density of SOFC is determined by the three irreversible losses:
1) Activation loss originated from slow oxygen reduction reaction rate at the cathode;
2) Ohmic loss stemming from slow ionic transport through electrolyte; and
3) Concentration loss caused by the limited gas (oxygen and fuel) supply to the electrode reaction sites.

Accordingly, there is a need to develop an SOFC which may reduce one, two, and/or all three of the primary fuel cell losses including activation loss, ohmic loss, concentration loss, for better performances at a certain operating temperatures or a lower operational temperature for desired power output to overcome the current shortcomings in the art.

### SUMMARY OF THE INVENTION

This present invention provides a membrane-electrode assembly of a solid oxide fuel cell (SOFC) and methods of fabrication thereof. The SOFC contains high functional thin films, which may reduce one, two and/or all three of the primary fuel cell losses including activation loss, Ohmic loss, concentration loss, for better performances at a certain operating temperatures or a lower operational temperature for desired power output.

One aspect of the current invention includes a membrane-electrode assembly having an electrolyte layer with a substantially constant thickness. The electrolyte layer has opposite first and second electrolyte layer surfaces, where the electrolyte layer is arranged in a three-dimensional pattern. The three-dimensional pattern has opposite first and second planar pattern surfaces. The three-dimensional pattern further has a first set of features extending inward from the first planar pattern surface, and a second set of features extending inward from the second planar pattern surface that is opposite to the first planar pattern surface. A first electrode layer is adjacent and conforming to the first electrolyte layer surface, and at least one mechanical support structure exists within some or all of the second set of features. A second electrode layer is adjacent and conforming to the second electrolyte layer surface and to at least one mechanical support structure.

In one embodiment of the invention, an SOFC with the membrane-electrode assembly described above is deposited on a substrate with a through hole. In one aspect, the substrate is a silicon wafer and in another aspect, the hole is a cylindrical through hole.

In one embodiment of the invention, the second electrode layer covers some or all of the walls of the through hole. According to one aspect, the first and second electrode layers are porous electrode layers. In another aspect, the electrolyte layer is a dense ionic conducting oxide membrane with a thickness of up to about 200 nanometers.

In another embodiment, the electrolyte layer is a composition-grading membrane having a varying dopant concentration, for example from a predominant concentration of the electrolyte to a predominant concentration of the electrode. This composition grading membrane may be fabricated using layer-by-layer deposition. According to another aspect, the electrode layers are composited with the electrolyte. Further, the electrode layers may contain a metal catalyst. In one aspect, the electrode layers may have a thickness up to 200 nanometers.

In one embodiment of the invention, the mechanical support layers are deposited to a top side and a bottom side of the substrate. In another aspect, the layers and structures are deposited using techniques such as DC/RF sputtering, chemical vapor deposition, pulsed laser deposition, molecular beam epitaxy, evaporation, and atomic layer deposition.

According to one embodiment of the invention, the fuel cell has a total thickness from 10 nanometers to 10 micrometers.

In another aspect of the invention, the boundaries between the electrolyte layer and the electrodes include a grain boundary formation.

### BRIEF DESCRIPTION OF THE FIGURES

The objectives and advantages of the present invention will be understood by reading the following detailed description in conjunction with the drawing, in which:

FIG. 1 shows an electrolyte layer-structure arranged in a three-dimensional pattern with support structure according to the present invention.

FIG. 2 shows a membrane-electrode assembly for use in a solid oxide fuel cell according to the present invention.

FIG. 3 shows a solid oxide fuel cell having a membrane-electrode assembly according to the present invention.

FIGS. 4a-4d show an embodiment of the steps for making a solid oxide fuel cell having a membrane-electrode assembly according to the present invention.

FIG. 5 shows an exemplary solid oxide fuel cell having relatively thick electrolyte and electrode layers according to prior devices.

FIG. 6 shows an exemplary thin solid oxide fuel cell where silicon provides support to the fuel cell structure according to the present invention.

FIGS. 7a-7m show an exemplary fabrication process based on single-crystal silicon wet etching according to the present invention.

FIG. 8 shows an exemplary two adjacent square solid oxide fuel cells fabricated by the method of FIGS. 7a-m according to the present invention.

FIG. 9a-9r show an exemplary fabrication process based on poly-crystalline structure wet etching according to the present invention.

FIGS. 10a-10r show an exemplary fabrication process based on silicon on insulator wafer etching according to the present invention.

FIGS. 10a2-2d show an alternate to the exemplary fabrication process of FIGS. 10a-r based on silicon on insulator wafer etching according to the present invention.

FIG. 11 shows an exemplary free-standing cup-shape structure fabricated by the method of FIGS. 9a-r according to the present invention.

FIG. 12 shows an exemplary side view of the corresponding exemplary design according to the present invention.

FIG. 13 shows a diagram indicating the maximum percentage of the effective fuel cell dependent on the thickness of the supporting wafer fabricated by the method of FIGS. 9a-r according to the present invention.

FIG. 14 shows an optical image of the cup-shape fuel cells fabricated by the method of FIGS. 9a-r according to the present invention.

FIG. 15 shows an SEM image of the fuel cell structure fabricated by the method of FIGS. 9a-r according to the present invention.

FIG. 16 shows an SEM image of the fuel cell structure fabricated by the method of FIGS. 9a-r according to the present invention.

FIG. 17 shows an I-V curve of the 3D-structured ultra thin solid oxide fuel cell fabricated by the method of FIGS. 9a-r according to the present invention.

FIG. 18 shows an SEM cross-section image of the fuel cell having a 50 nanometers highly ion-conductive electrolyte GDC between the porous cathode and dense electrolyte layer according to the present invention.

FIG. 19 shows an I-V curve of an ultra thin solid oxide fuel cell having 50 nanometers highly ion-conductive electrolyte according to the present invention.

FIG. 20 shows an exemplary I-V curve of an ultra thin SOFC consisting porous Pt-YSZ composite electrode on dense electrolyte

### DETAILED DESCRIPTION OF THE INVENTION

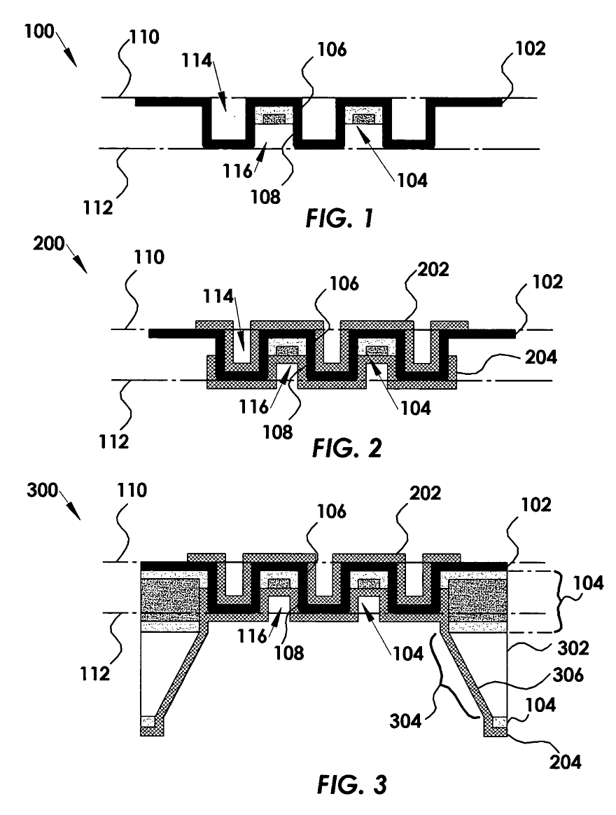

FIG. 1 shows an electrolyte layer-structure arrangement 100 having an electrode layer 102 arranged in a three-dimensional pattern with support structure 104. The electrolyte layer 102 has a substantially constant thickness and opposite first and second electrolyte layer surfaces (106/108, respectively). Electrolyte layer 102 is arranged in a three-dimensional pattern having opposite first and second planar pattern surfaces (110/112, respectively). The three-dimensional pattern has a first set of features 114 extending inward from the first planar pattern surface 110, and a second set of features 116 extending inward from the second planar pattern surface 112 opposite to the first planar pattern surface 110 of the three-dimensional pattern.

FIG. 2 shows a membrane-electrode assembly 200 for use in a solid oxide fuel cell, which includes a first electrode layer 202 adjacent and conforming to the first electrolyte layer surface 106, and at least one mechanical support structure 104 within some or all of the second set of features 116. The membrane-electrode assembly 200 further includes a second electrode layer 204 adjacent and conforming to the second electrolyte layer surface 204 and to at least one mechanical support structure 104.

FIG. 3 shows a solid oxide fuel cell 300 with a membrane-electrode assembly like 200. Membrane-electrode assembly 200 is deposited on a substrate 302 with a through hole 304. Further shown in FIG. 3, the second electrode layer 204 covers some or all of the walls 306 of the through hole 304. The first and second electrode layers (202/204, respectively) are porous electrode layers. Further, the substrate 302 can be a silicon wafer, and the hole 304 can be a cylindrical through hole.

The electrolyte layer 102 can be a dense ionic conducting oxide membrane with a thickness up to 200 nanometers. Further, the electrolyte layer 102 may be a composition-grading membrane having a varying dopant concentration from a predominant concentration of the electrolyte 102 to a predominant concentration of the electrode (202/204), where the composition-grading membrane can be fabricated using layer-by-layer deposition.

In addition, the electrode layers (202/204) could be composited with the electrolyte 102. Furthermore, the electrode layers (202/204) could contain a metal catalyst. The electrode layers (202/204) have a thickness up to about 200 nanometers.

As shown in FIG. 3, the mechanical support layers are deposited to a top side and a bottom side of the substrate. The solid oxide fuel cell 300, according to one aspect of the invention, has the layers (102, 202, 204) and the structures 104 deposited using techniques such as DC/RF sputtering, chemical vapor deposition, pulsed laser deposition, molecular beam epitaxy, evaporation, and atomic layer deposition. Accordingly, the fuel cell 300 has a total thickness from 10 nanometers to 10 micrometers.

In another aspect of the thin film solid oxide fuel cell 300, the boundaries between said electrolyte layer 102 and the electrodes (202/204) may be a grain boundary formation (not shown).

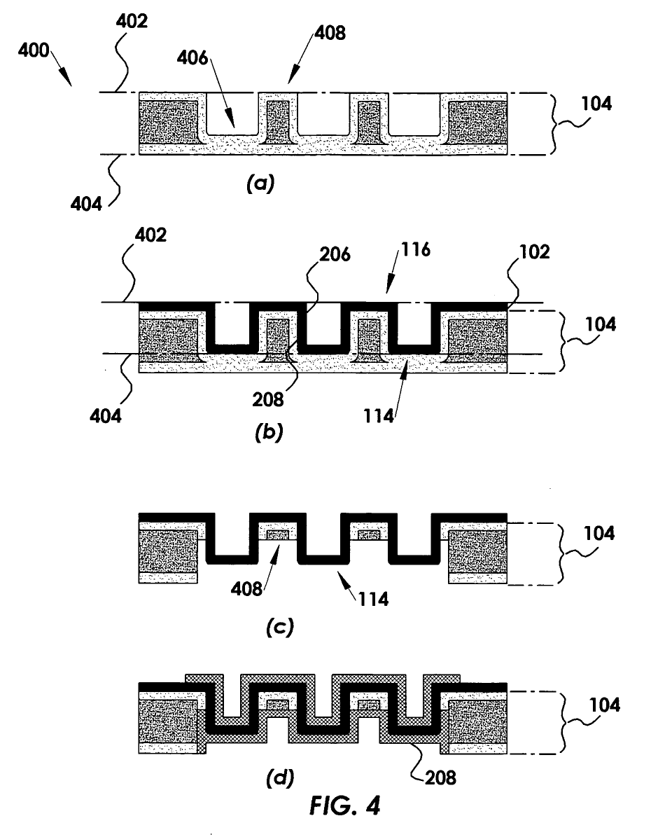

FIGS. 4a-4d show steps for making a solid oxide fuel cell having a membrane-electrode assembly. Fabrication method 400 of making a membrane-electrode assembly 200 provides the step of making a mechanical support structure 104 with opposite first and second mechanical support structure layer surfaces (402, 404, respectively). In this process, the mechanical support structure 104 is arranged in a first three-dimensional pattern. The first three-dimensional pattern has a first set of structure features 406 extending inward from the first mechanical support structure layer surface 402, and a second set of structure features 408 extending inward from the second mechanical support structure layer surface 404 opposite to the first mechanical support structure layer surface 402. An electrolyte layer 102, of substantially constant thickness, is deposited to the mechanical support structure first layer surface 402 and conforms with the mechanical support structure first three-dimensional pattern made from the first set of structure features 406 and the second set of structure features 408. In FIG. 4b, the electrolyte layer 102 has opposite first and second electrolyte layer surfaces (206/208), and, for this process, the electrolyte layer 102 is arranged in a second three-dimensional pattern. The second three-dimensional pattern has a first set of electrolyte features 114 extending inward from the first electrolyte layer surface 402, and a second set of electrolyte features 116 extending inward from the second electrolyte layer surface 404 that is opposite to the first layer surface 402 of the second three-dimensional pattern. FIG. 4d depicts a first electrode layer 202 is deposited adjacent to and conforming with the first electrolyte layer surface 106. In FIG. 4c the first set of mechanical support structure features 406 is removed and a portion of the second mechanical support structure features 408 is removed, where a remaining portion of the second mechanical support structure features 408 and the first set of electrolyte features 114 are exposed to form a third three-dimensional pattern made from the first electrolyte features 114 and the mechanical support structure 104/408. A second electrode layer 204 is deposited adjacent to and conformal within the second electrolyte layer surface 208 and with the remaining second mechanical support features 408. In one aspect of the method of making a solid oxide fuel cell 300, the membrane-electrode assembly 200 is deposited on a substrate 302 with a through hole 304 (see FIG. 3).

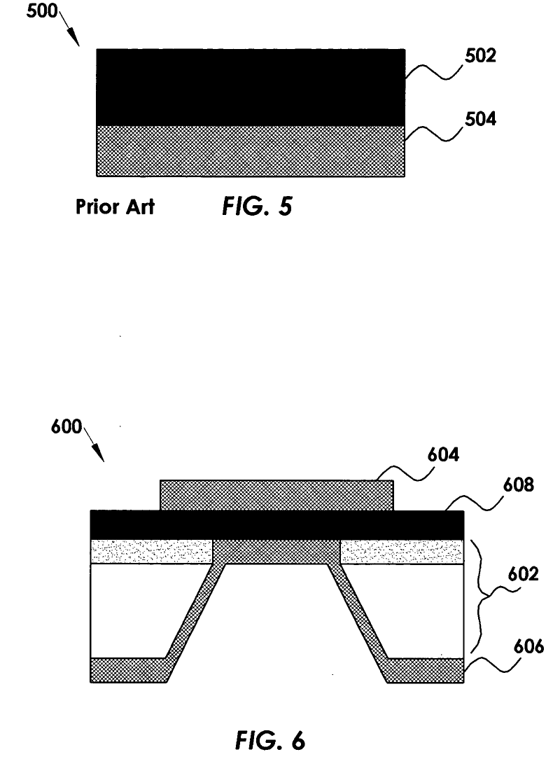

FIG. 5 shows an example of a prior solid oxide fuel cell 500. The thicknesses of dense electrolyte 502 and/or porous electrodes 504 are quite large. The thick electrolyte 502 and electrode layers 504 lead to high resistance. The thick electrode layer 504 also leads to long path for gas diffusion, and hence larger concentration loss.

According to the present invention, FIG. 6 illustrates the challenges of developing thin SOFCs (compared and in contrast to FIG. 5) regarding mechanical stability, electrical integrity (no shorts), and gas tightness (no leakage). Special structure designs and fabrication methods for manufacturing a thin, defect free, and high power SOFC are necessary. To maintain the mechanical integrity of the thin SOFC structure, a supporter structure with a certain thickness is needed. FIG. 6 shows an exemplary thin fuel cell 600 where Si is a supporter 602 of the thin fuel cell structure 600, where a first and second electrode (604, 606) and a planar electrolyte layer 608 are shown.

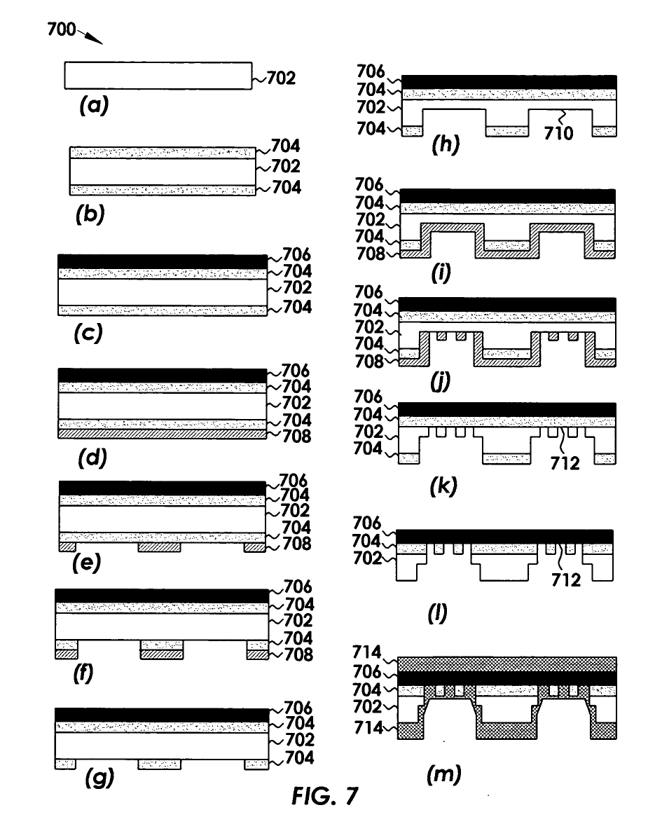

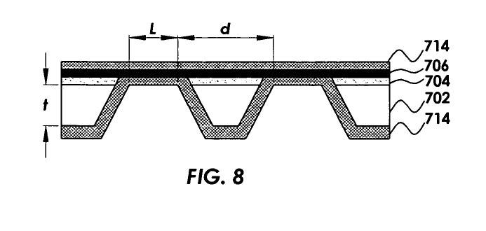

FIGS. 7a-7m shows a single-crystal silicon wet etching fabrication method 700. FIG. 7a shows a silicon wafer that serves as support for the thin film SOFC. The wafer is 4-inch in diameter, 375 micrometers thick and double-polished. To prevent the electrical current from leaking and avoiding reaction between Si and YSZ, a 500 nanometers thick low-stress silicon nitride layer 704 is deposited onto both sides of the wafer by low-pressure chemical vapor deposition (LPCVD), as depicted in FIG. 7b. On one side (top) of the Si wafer 702, an electrolyte film 706, for example YSZ and/or GDC, is deposited by RF sputtering at 200 degrees Celsius (see FIG. 7c). Shown in FIG. 7d, on the other side (bottom), photoresist 708 (3612 positive resist from Shipley Co.) was coated with designed mask. FIG. 7e illustrates the photoresist 708 exposed and developed. The exposed part of photoresist is removed by piranha. Shown in FIG. 7f, the exposed bottom layer of silicon nitride 704 is removed by RIE-etching (reactive ion etching), and in FIG. 7g, The photoresist 708 residue was stripped off by piranha. Shown in FIG. 7h, the opened large Si windows 710 were partially removed by RIE-etching (reactive ion etching). Etching time controls the thickness. In FIG. 7i, the photoresist 708 (3612 positive resist from Shipley Co.) was coated with designed mask, and in FIG. 7j, the exposed and developed photoresist is removed. Shown in FIG. 7k, the opened small Si windows 712 were etched with 30% KOH at temperatures of 85-90 degrees Celsius. In FIG. 7l, silicon nitride 704 (top) in the window structure 712 as well as that on top of the Si wafer 702, was etched away by RIE-etching. Finally, in FIG. 7m, by using physical masks, dense or porous electrode films 714 (cathode and anode) were patterned on both sides of YSZ 706.

To maintain the mechanical strength under pressure the effective fuel cell surface area are limited to the range from 2.5e-9 to 1.6e-7 m². Examples of side length dimensions for square-profiled small fuel cells include 50, 75, 100, 150, 190, 245, 290, 330, 370, 375, and 400 micrometers. FIGS. 7a-7m show an exemplary two adjacent square fuel cells, which could be fabricated by the method described. Referring to FIG. 8, L represents the length of an active fuel cell square through hole, d represents the width of the supporter (also referred to as spacing), and t represents of the thickness of the wafer supporter. Due to the crystalline structure orientation, the angle between the etching side of Si supporter and the electrolyte is always 54 degrees. Therefore the relationship between the minimum spacing d and the thickness of wafer t is

$$d = \frac{2 t}{tan 54} = 1.45 t$$

The percentage of the effective fuel cell area (A_{eff}/Aₜₒₜₐₗ) depends on the thickness of the supporting wafer,

$$\frac{{A}_{eff}}{{A}_{total}} = \frac{{L}^{2}}{{( L + d )}^{2}} = \frac{1}{{( 1 + \frac{d}{L} )}^{2}} = \frac{1}{{( 1 + \frac{1.45 t}{L} )}^{2}}$$

An alternate fabrication approach is provided, which is based on poly-crystalline structure layer wet etching. To realize this concept with MEMS fabrication, a structure layer is added onto the etch stop layer on the wafer. This structure layer is placed on top of the etch stop (silicon dioxide or silicon nitride) of KOH wet etching. The thickness can be several micrometers. The advantages of adding this structure layer are:
1) The exact size of the single cell can be patterned on this structure layer. Unlike the fabrication method described in FIGS. 7, where the exact size of each single cell is determined after the silicon KOH wet etching, the single cells are now directly patterned on the structure layer for required sizes.
2) The shape of single cells can be patterned as circle for even stress distribution. The square shape of wet etching window induces stress on both axial directions. Patterning the circular cells on the structure layer can help to distribute the compression stress of YSZ thin film to all direction.
3) The structure layer can be patterned and etched for more surface area: Since the electrolyte will be deposited on the patterned surface, the electrolyte thin film may extrude to form a 3D structure. By etching away part of the structure layer, more surface area of electrolyte can be exposed for electrochemical reaction.
4) The thick structure layer enables larger window of KOH etching while maintaining small single cell size. Since the thickness of the structure layer is several micrometers, more mechanically stable single cells may be obtained by designing small patterns on the structure layer. Therefore, it is feasible to achieve large openings but maintain the stability of the structure layer by using wet etching process. As a result, spacing between windows can be reduced and the percentage of effective reaction area is increased.
5) Single fuel cells can be arranged in close packed layout to maximize surface area. Circular single cells on the structure layer can be designed close-packed patterns with minimized spacing so that the usage of surface area is maximized.

To realize this, a structure layer will be added onto the etch stop layer on the wafer. For example, this structure layer is placed on top of the etch stop (silicon dioxide or silicon nitride) for KOH wet etching. The thickness can be one to a few tens of micrometers. The structure layer is polycrystalline silicon, which can be deposited by chemical vapor deposition (CVD) or can be used the commercial SOI (silicon on insulator) wafer containing polycrystalline silicon layer.

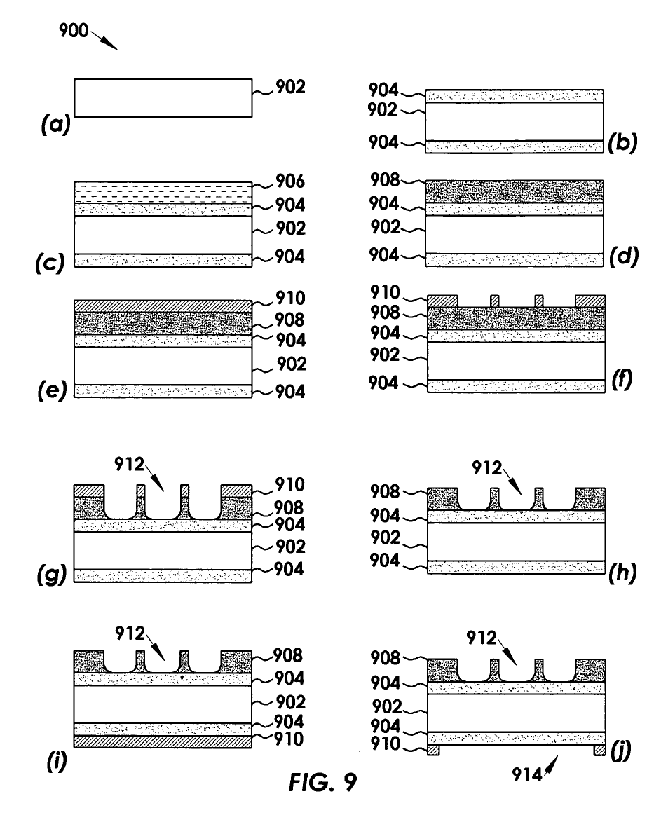

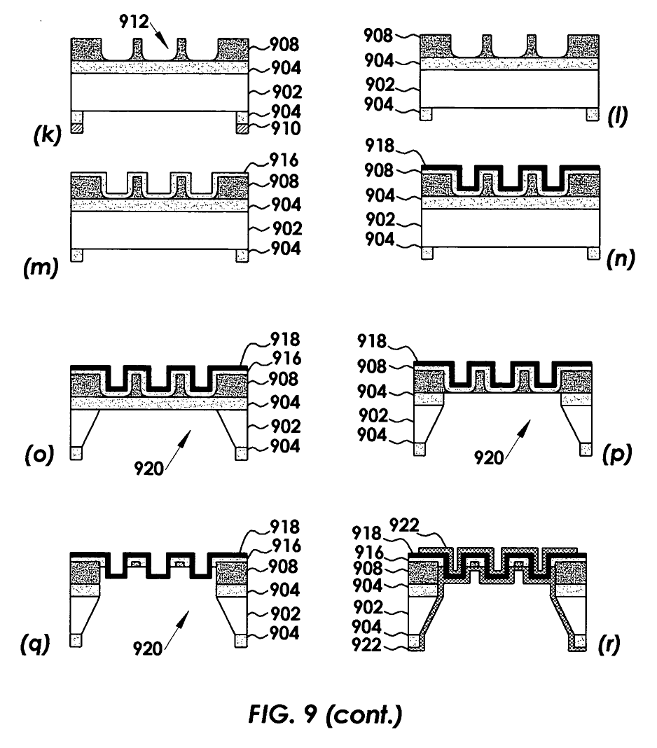

An exemplary fabrication process including depositing polycrystalline silicon is shown in FIGS. 9a-9r, where in FIG. 9a, a double-side polished {100} silicon wafer 902 is provided having a thickness of 350 micrometers. FIG. 9b shows 500 nanometers low stress silicon nitride layers 904 deposited on both sides of the wafer 902. FIG. 9c shows polycrystalline silicon layers 906 deposited on top of the structure. Next, FIG. 9d shows an annealed polycrystalline silicon layer 908. The annealing is to reduce the compressive stress of the polycrystalline silicon. In FIG. 9e, a 1.6 micrometers thick photoresist 910 (3612 positive resist from Shipley Co.) is spin coated on the annealed polycrystalline silicon. FIG. 9f illustrates photolithography to make a mask with circles, which are arranged as close-packed layout. Circle sizes, for creating cylindrical holes, may range from 5 micrometers to 100 micrometers in diameter. FIG. 9g shows the results of plasma etching to make cylindrical cup-shaped trenches 912 on the annealed polycrystalline silicon structure layer 908, where the annealed polycrystalline silicon allows for cylindrical hole shapes. The depth of the cups is several micrometers, depending on the thickness of the structure layer 908. FIG. 9h shows the photoresist 910 removed using Piranha solution. FIG. 9i illustrates spin coat layer of 1.6 micrometers thick photoresist 910 (3612 positive resist from Shipley Co.) on the backside (bottom) silicon nitride 904. FIG. 9j depicts photolithography to pattern the silicon nitride 904 as a mask for KOH etching. The open windows 914 of silicon sized from 2 millimeters to 6 millimeters. FIG. 9k depicts the silicon nitride 904 etched by RIE with 100 sccm SF₆, 10 sccm O₂, 83 W of power and 150 mTorr of pressure. Shown in FIG. 9l the photoresist 910 is removed in Pirahna solution. FIG. 9m shows a layer of 200 nanometers thick silicon nitride 916 deposited on the cup-shaped trenches 912 and covering the top side of the structure. This tensile stressed silicon nitride layer 916 is to stabilize the compression stress of the to-be deposited YSZ electrolyte layer, where the deposit electrolyte layer 918 (for example, YSZ), depicted in FIG. 9n, is deposited by thin film deposition methods, such as atomic layer deposition (ALD) or sputtering. FIG. 9o shows the opened Si windows 920 as being etched with 30% KOH at temperatures of 85-90 degrees Celsius. FIG. 9p illustrates the first layer of silicon nitride 904 (wafer top) etched away by RIE at 100 sccm SF₆, 10 sccm O₂, 83 W of power and 150 mTorr of pressure. Shown in FIG. 9q is further etching of the 200 nanometers thick silicon nitride 916 and the annealed polycrystalline silicon 908 to release the buried electrolyte 918 (YSZ) surface. The etching is done with RIE at 100 sccm SF₆, 10 sccm O₂, 83 W of power and 150 mTorr of pressure. Finally, shown in FIG. 9r, a 120 nanometers thick layer of porous platinum is deposited on both sides of the electrolyte 918 as electrodes 922 (and catalyst) to finish the process.

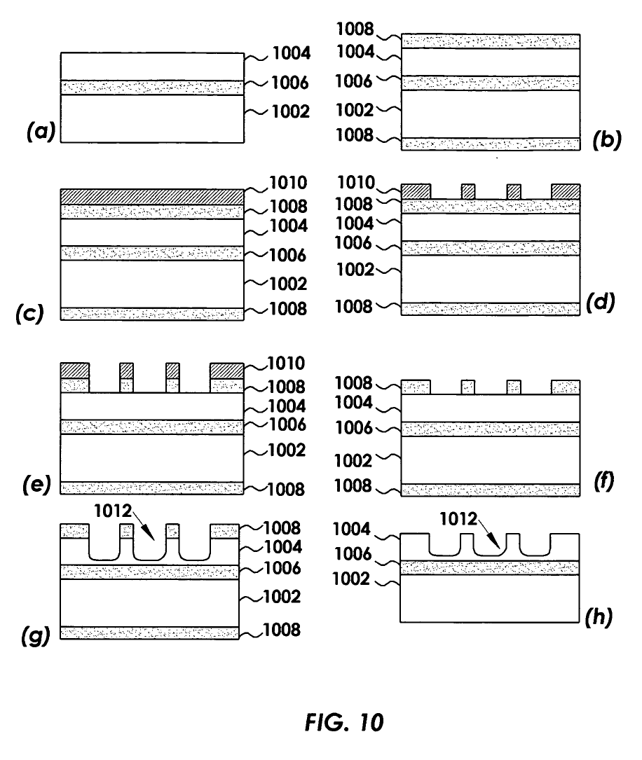

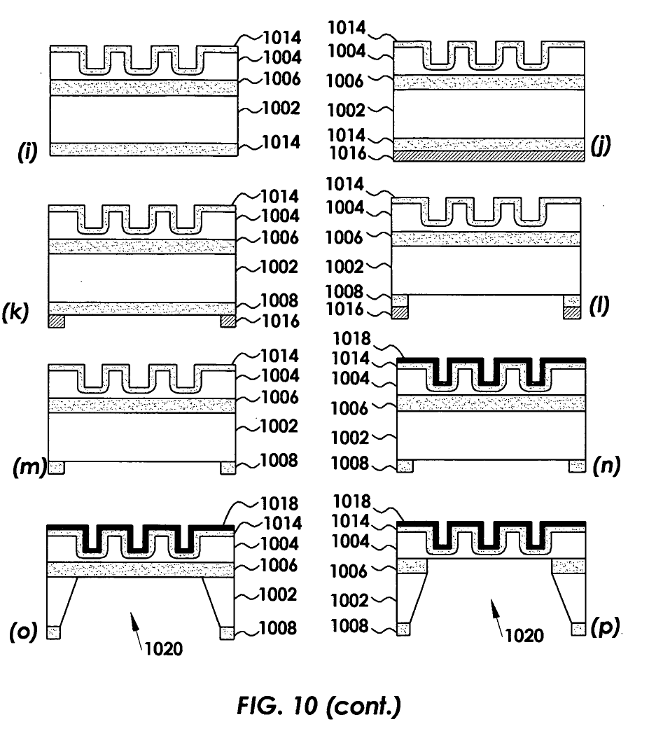

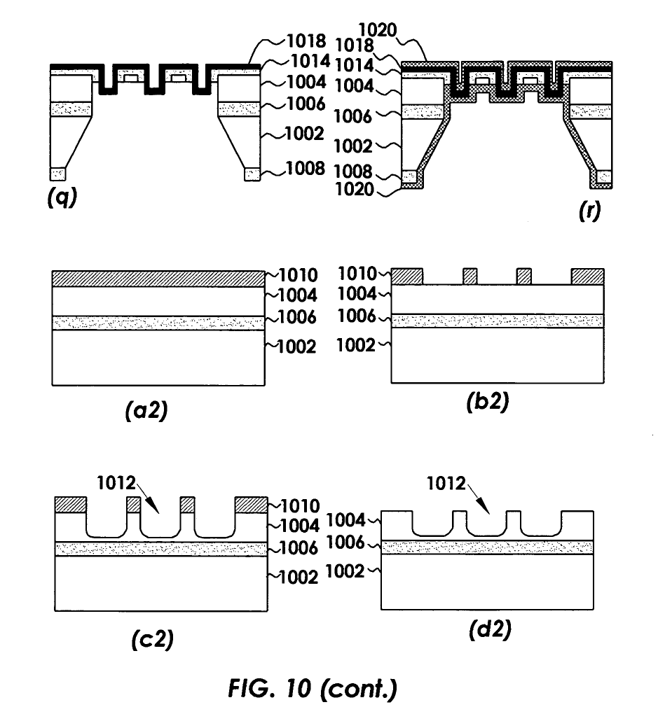

FIGS. 10a-10r shows another exemplary process which starts with an SOI (silicon on insulator) wafer. The polycrystalline silicon and silicon oxide layer on SOI act as the structure layer. FIG. 10a shows the process beginning with a double-side polished {100} SOI wafer with handle wafer 1002 having a thickness of 350 micrometers and device layer 1004 (structure layer here) thickness of 10-20 micrometers, where a silicon oxide layer 1006 is there between. FIG. 10b shows a 600 nanometers of thermal oxide 1008 grown on both sides of the SOI wafer, which is used as mask materials to pattern the structure layer. FIG. 10c shows a layer of 1 micrometer 3612 photoresist 1010 that is spin-coated on the device layer oxide 1008. FIG. 10d shows the use of photolithography methods to pattern the photoresist 1010 into the designed structure, e.g. close-packed circles. FIG. 10e shows the thermal oxide layer 1008 patterned underneath with O₂ and CH₃ plasma etching. FIG. 10f depicts the photoresist layer 1010 removed, resulting the patterned thermal oxide layer 1008 in the designed pattern structure. FIG. 10g shows the use of plasma-etching to generate cup-shaped trenches 1012 in the polycrystalline silicon structure layer 1004. The depth of the cups 1012 can be in the range of one to a few tens of micrometers, depending on the thickness of the structure layer 1004. Note that here the structure should not be totally etched to the buried oxide 1006. Shown in FIG. 10h is the thermal oxide mask 1008 removed in 6:1 buffered oxide etch (BOE) solution. Shown in FIG. 10i is 200 nanometers of low stress silicon nitride 1014 on both sides of the SOI wafer structure. FIG. 10j shows 1.6 micrometers thick photoresist 1016 (3612 positive resist from Shipley Co.) spin coated on the backside silicon nitride 1014. Shown in FIG. 10k is a photolithographic pattern on the silicon nitride 1008 from the layer of photoresist 1016, which is used as a mask for Si opening windows in the following step. The pattern of silicon nitride, and hence, the open windows of silicon can be in the range of 0.5 to 10 millimeters, shown in FIG. 10l showing an etched silicon nitride layer 1008 by Reactive Ion Etching with 100 sccm SF₆, 10 sccm O₂, 83 W of power and 150 mTorr of pressure. In FIG. 10m, the photoresist layer 1016 is removed in Pirahna solution. FIG. 10n illustrates an electrolyte layer 1018 (for example YSZ) deposited by thin film deposition methods, such as ALD or sputtering to the topside silicon nitride layer 1014. In FIG. 10o the opened Si windows 1020 were etched with 30% KOH at temperatures of 85-90 degrees Celsius, and in FIG. 10p, the buried oxide 1006 etch stop was removed with 6:1 BOE solution. Shown in FIG. 10q are the silicon nitride layer 1014 and the polycrystalline silicon layer 1004 etch further away to release the buried YSZ electrolyte 1018 surface. The etching is done with RIE at 100 sccm SF₆, 10 sccm O₂, 83 W of power and 150 mTorr of pressure. Finally, 120 nanometers thick of porous platinum electrodes 1020 are deposited on both side of the YSZ electrolyte 1018 as electrodes and catalyst to finish the process.

If photoresist 1010 is chosen as a mask for the top patterning, the processes can be simplified. The processing used according to FIGS. 10a2-10d2 illustrates the simplification. In FIG. 10a2 a 1 micrometer of 3612 photoresist 1010 is spin coated on the structure layer 1004, which is used as a mask material to pattern the structure layer 1004. In FIG. 10b2, the process proceeds directly with photolithography to pattern circular individual cells. FIG. 10c2, illustrates the results of plasma etching to make cup-shaped trenches 1012 on the polycrystalline silicon structure layer 1004. The depth of the cups 1012 is several micrometers depending on the thickness of the structure layer 1004. Note that here the structure should not be totally etched to the buried oxide 1006. Remove the photoresist layer 1010 resulting the patterned thermal oxide layer 1004 in the designed pattern structure of FIG. 10h, whereby several steps have been removed from the fabrication process.

By using the above fabrication methods, the electrode and electrolyte thin films can be deposited on the pre-designed three-dimension surface. Depending on the geometry of the surface to be deposited, the deposited thin films will transfer the geometry to form a three dimensional structure.

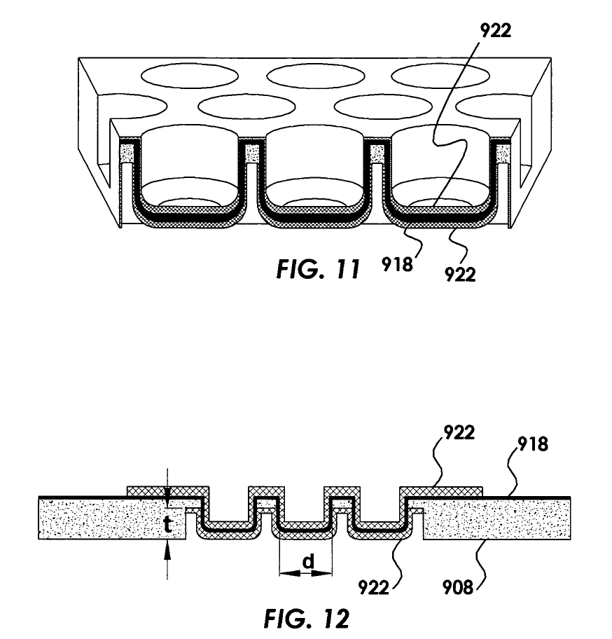

FIG. 11 shows an exemplary art of the three-dimensional cup-shaped fuel cell structure, which may be obtained by fabrication method described in FIGS. 9. As shown, the cup-shaped fuel cell structure has an electrolyte layer 918 located between two electrode layers 922 on the top and bottom surfaces.

FIG. 12 shows an exemplary side view of the corresponding exemplary design that, where an electrolyte layer 918 is located between two electrode layers 922 on the top and bottom surfaces that are supported by an annealed polycrystalline layer 908. The drawing shows the geometric increase factor of fuel cell effective area can be estimated according to the structure design. For example, the effective area of the bottom and the side-wall of fuel cells are considered separately.

From a top view, the fuel cells are close-pack circles with a diameter represented by D. The area of each circle include area of each fuel cell and spacing. The maximum area on planar surface with the close packed cup bottom is 90.69%. By introducing kD (0<k<1) spacing between cells for structure strength purpose, the diameter of the cells becomes (1−k)D. The effective area of the cup bottom part (EA_{bottom}) then decreased to
EA_{bottom}=0.9069×(1−k)²

From the side view, it can be seen that the height and the diameter of each cup are represented by Δt and d respectively. Here d=D(1−k). Then the side wall effective area (EA_{sidewall}) of the cups can be represented with the aspect ratio (A.R.) of the cup depth (Δt) and cup diameter (d). The aspect ratio (A.R.) is

$$A . R . = \frac{Δ t}{d}$$

Therefore the ratio between the side-wall area and the bottom area can be expressed as

$$\frac{{EA}_{sidewall}}{{EA}_{bottom}} = \frac{{A}_{sidewall}}{{A}_{bottom}} = \frac{π d Δ t}{π {d}^{2} / 4} = 4 \frac{Δ t}{d} = 4 A . R . \\ {EA}_{sidewall} = 4 A . R . \times {EA}_{bottom}$$

The total effective area is obtained by combining the two equations above into:
EAₜₒₜₐₗ=EA_{bottom}+EA_{sidewall}=(1+4A.R.)×└0.9069 (1−k)²┘

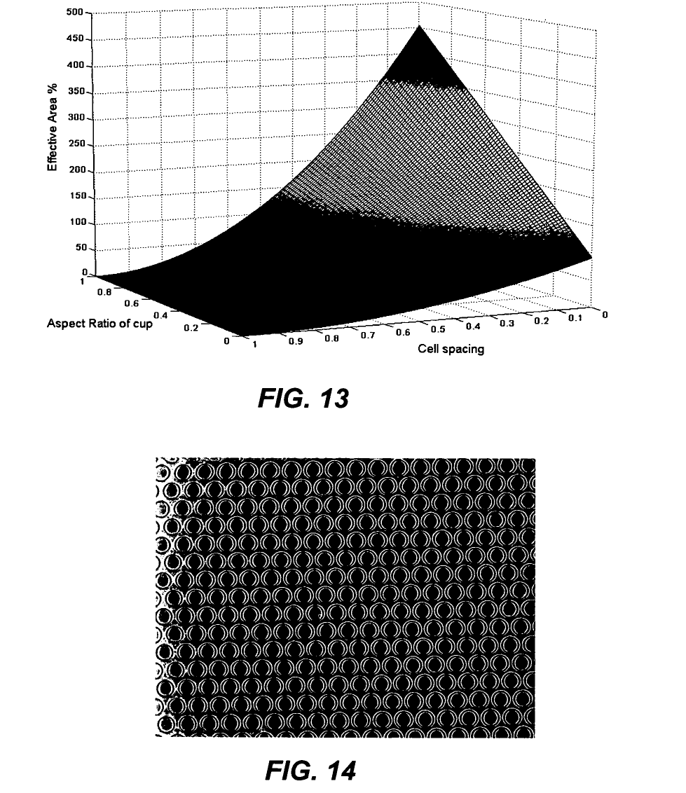

The last equation indicates that the effective area (EAₜₒₜₐₗ) of the exemplary fuel cell structure design is determined by the spacing between individual cells (k) and the aspect ratio of the cups (k). The plot of this equation is shown in FIG. 13. For example, if a 3 dimensional fuel cell with circle diameter=10 micrometers, spacing=2 micrometers, and depth 10 micrometers, then k=0.2 and A.R.=1. The EAₜₒₜₐₗ is 2.9, which means that 2.9 times of the wafer surface area can be used for electrochemical reaction. A larger effective fuel cell area than the geometric area of the supporter may be achieved by the 3D-structure design and fabrication.

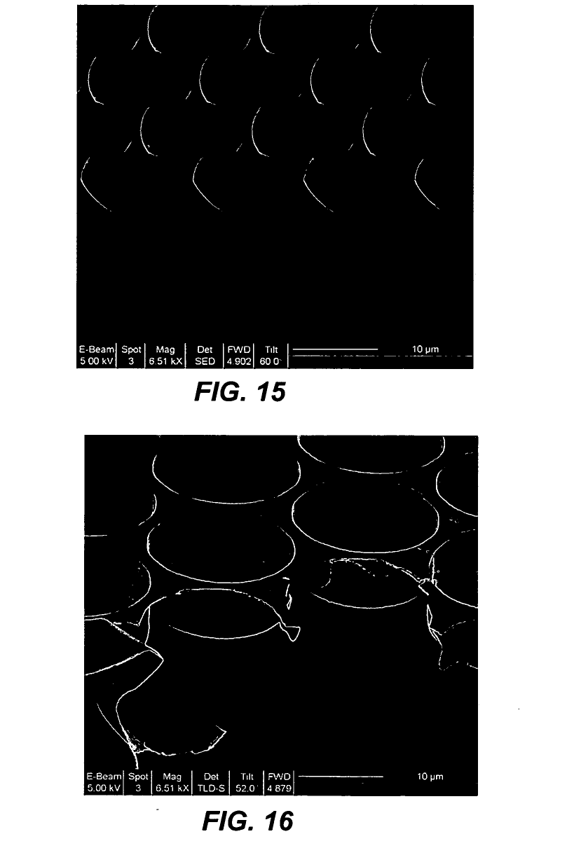

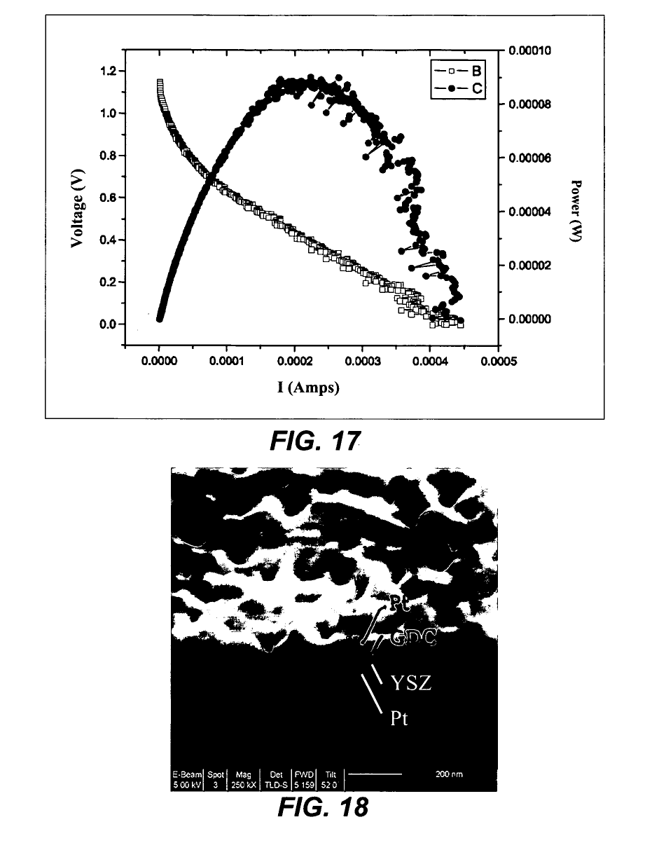

FIG. 14 show an optical image of 2D structure design to enlarge the effective area of ultra-thin SOFCs. The diameter of each individual fuel cell is 50 micrometers and the spacing is 10 micrometers. FIG. 15 and FIG. 16 show scanning electron microscopy (SEM) images of two 3D structure designs to enlarge the effective area of ultra-thin SOFCs. The diameter of each individual fuel cell shown in FIG. 15 is 50 micrometers and the spacing is 10 micrometers. The detail parameters of the fuel cell shown in FIG. 16 are as the following: the diameter of each individual fuel cell is 15 to 20 micrometers, the spacing is 3 micrometers, and the cup depths are 10 to 20 micrometers. The fuel cell performance of this 3D-structured ultra thin SOFC is evaluated. Open circuit voltage (OCV) close to theoretical value, i.e. 1.14V, has been achieved and the maximum power density is 9×10⁻⁵ W at 400 degrees Celsius. FIG. 17 shows the I-V curve of the measured 3D-structured ultra thin SOFC fabricated by the method of FIGS. 9a-r.

A thin smooth electrolyte layer (YSZ and GDC) may be fabricated between non-smooth nanoporous Pt layers. YSZ and/or GDC may be deposited on a smooth SiN layer. Pt may be deposited onto the YSZ and/or GDC layer after etching of the SiN. Nano-scale porosity in the Pt films may be achieved by varying the sputtering conditions (i.e. high Ar pressure and low DC power).

With respect to the electrolyte, several kinds of materials may be used. A Zr—Y (84/16 at %) alloy target and a Ce—Gd (90/10, 80/20, 75/25 at %) alloy target can be used for electrolyte deposition by DC-magnetron sputtering. These metal films can be oxidized after deposition using the post oxidation method. An 8YSZ (8 mole % yttria stabilized zirconia) target may be used in RF-magnetron sputtering. Exemplary deposition conditions for each electrolyte film are summarized in Table 1. Following this step, a Pt layer was deposited on top of the electrolyte layer with the same conditions as the lower Pt electrode.

TABLE 1
Sputtering conditions for the electrolyte materials

| | Target material | | | |
|---|---|---|---|---|
| | YSZ | GDC | GDC | YSZ |
| Sputtering method | DC | DC | RF | RF |
| Gas flow (sccm) | Ar: 30 | Ar: 30 | Ar: 40-100; | Ar: 40-100; |
| | | | O₂: 5-40 | O₂: 5-40 |
| Power* (W) | 50-100 | 100-200 | 300 | 300 |
| Ar pressure (Pa) | 1-3 | 1-5 | 5 mTorr | 5 mTorr |
| Substrate temperature (° C.) | R.T. | R.T. | 200 | 200 |
| Deposition rate | 0.5-3 nm/sec | 0.5-3 nm/sec | 0.1-2 nm/min | 0.5-3 nm/sec |
| Oxidation temperature (° C.) | 500-700 | 500-700 | | N/A |
| Oxidation duration (h) | 5 | 5 | | N/A |

*The target size for DC- and RF- sputtering may be 2 and 4 inch respectively.

Ionic conducting property (conductivity) of the electrolyte membrane is decided by the concentration of oxygen vacant site (oxide-ion vacancy) and mobility of these vacancies. In the solid electrolyte, the oxygen ion concentration is directly related to the dopant concentration. An oxygen ion concentration gradient can be artificially built up in the electrolyte membrane by varying dopant concentration, e.g. Y in YSZ and Gd in GDC. This structured-membrane can be referred to as composition-grading membrane. It can be fabricated via-layer-by-layer deposition. The high concentration gradient in the composition-grading membrane will lead to high performances of SOFC by reducing ohmic loss.

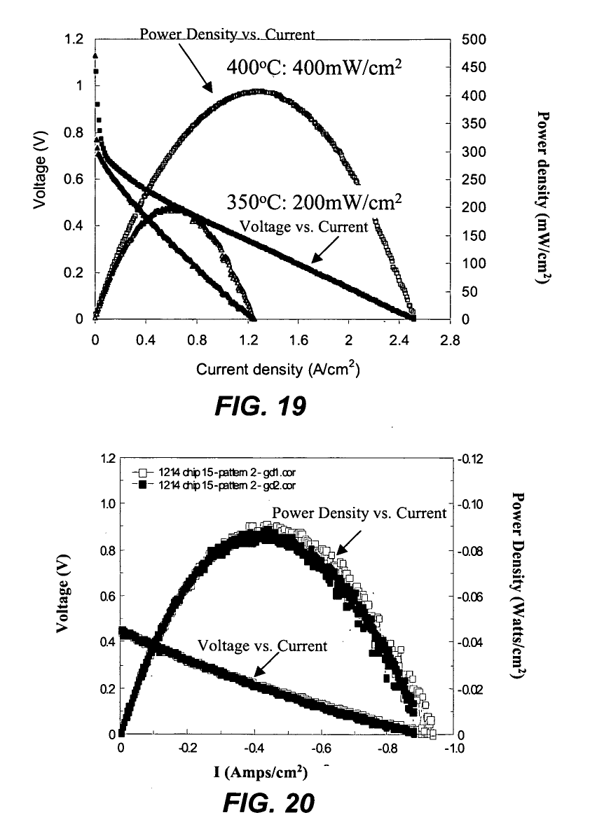

The oxygen reduction reaction rate is related with the morphology and nature of the electrolyte. High reaction rate is found on high ionic-conducting electrolyte materials. On the top of the thin dense electrolyte YSZ, a dense GDC layer may be added between the cathode Pt and YSZ. Porous nanocrystalline YSZ and/or GDC may be added. At such an artificially designed interface oxygen reduction process can proceed faster leading to decreased activation loss. FIG. 18 illustrates a SEM cross-section images of a fuel cell consisting of a GDC interlayer between a porous Pt cathode and a YSZ dense electrolyte. FIG. 19 shows an exemplary I-V performance of such fuel cell obtained in the temperature range of 300 degrees Celsius and 400 degrees Celsius. The OCV was 1.10V in the temperature range used. A peak power density of 200 mW/cm² at 350 degrees Celsius was achieved. At 400 degrees Celsius the maximum power density reached was 400 mW/cm². The peak power density at 300 degrees Celsius dropped to 55 mW/cm².

The catalyst like Pt, used in the electrode, can be composited with electrolyte material. This will result in more active sites for the electrochemical reactions, i.e. reduction of oxygen at the cathode and oxidation of fuel molecule at anode. Such a dense or porous thin catalyst/electrolyte composite membrane is expected to increase the electrochemical reaction loss and hence, decrease activation loss. FIG. 20 shows an exemplary I-V curve of the thin SOFC consisting of a porous Pt-YSZ composite cathode. Although the OCV is low due to the gas and current leakage, maximum power density close to 100 mW/cm² has been achieved at 350 degrees Celsius. In addition, the catalyst/electrolyte composite membrane has similar behavior upon temperature change (thermal expansion coefficient) to electrolyte membrane. Therefore by using catalyst/electrolyte composite membrane as in SOFC, good stability upon heating /cooling as well as operating at a certain temperature can also be maintained. A dense or porous Pt/GDC or Pt-YSZ composite layer may be achieved by co-sputtering. Co-sputtering is defined by igniting two guns at the same time; one gun is Pt target, while the other gun is YSZ or GDC target. By varying each gun's sputtering conditions, various porosity and composition ratios of Pt and the electrolyte can be achieved. The deposition conditions for each type of electrode films are summarized in Table 2.

TABLE 2
Sputtering conditions for the electrode materials

| | Target material | | |
|---|---|---|---|
| | Pt | Pt/GDC | Pt/YSZ |
| Sputtering method | DC | RF | RF |
| Gas flow (sccm) | 30 | Ar: 40-100; | Ar: 40-100; |
| | | O₂: 5-40 | O₂: 5-40 |
| Power* (W) | 100 | Pt: 30-100 | Pt: 30-100 |
| | | GDC: 300 | GDC: 300 |
| Ar pressure (Pa) | 10 | 5-75 mTorr | 5-75 mTorr |
| Substrate temperature | R.T. | 200o C. | 200 |
| (° C.) | | | |
| Deposition rate | 0.2-2 nm/sec | 0.2-5 nm/min | 0.2-5 nm/min |

*The target size for DC- and RF- sputtering may be 2 and 4 inch respectively.

For a dense substrate, electrolyte, and electrode, a relative density greater than 80% is preferable. A relative density greater than 90% may be more preferable. A relative density greater than 95% may be even more preferable. The densities are relative to the maximum theoretical material density. If porosity is zero, then relative density is 100%.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, variations in the size, shape and thickness of the patterned features, and the respective interlayers may be varied. Details of the fabrication processes such as etching and masking may be varied. Optimization of the utilized geometric area can be facilitated using pre-designed three-dimensional surfaces fabricated using MEMS/NEMS technologies.

Ionic conducting property (conductivity) of electrolyte membrane is decided by the concentration of oxygen vacant site (oxide-ion vacancy) and mobility of these vacancies. In solid electrolyte, oxygen ion concentration is directly related to the dopant concentration. Oxygen ion concentration gradient can be artificially built up in the electrolyte membrane by varying doptant concentration, e.g. Y in YSZ and Gd in GDC. This structured-membrane can be referred to as composition-grading membrane. It can be fabricated via-layer-by-layer deposition. The high concentration gradient in the composition-grading membrane will lead to high performances of SOFC by reducing ohmic loss.

Oxygen reduction reaction rate is related with the morphology and nature of electrolyte. High reaction rate is found on high ionic-conducting electrolyte materials. On top of thin dense electrolyte YSZ, dense GDC layer may be added between cathode Pt and YSZ. Porous nanocrystalline YSZ and/or GDC may be added. At such artificially designed interface oxygen reduction process can proceed faster leading to decreased activation loss.

The catalyst like Pt, used in the electrode, can be composited with electrolyte material. This will result more active sites for the electrochemical reactions, i.e. reduction of oxygen at the cathode and oxidation of fuel molecule at anode. Such dense or porous thin catalyst/electrolyte composite membrane is expected to increase the electrochemical reaction loss and hence, decrease activation loss.

All such variations are considered to be within the scope and spirit of the present invention as defined by the following claims and their legal equivalents.

What is claimed is:

1. A membrane-electrode assembly for use in a solid oxide fuel cell, comprising:
a. an electrolyte layer having a substantially constant thickness and having opposite first and second electrolyte layer surfaces, wherein said electrolyte layer is arranged in a three-dimensional pattern having opposite first and second planar pattern surfaces, wherein said three-dimensional pattern has a first set of features extending inward from said first planar pattern surface, and a second set of features extending inward from said second planar pattern surface opposite to said first planar pattern surface of said three-dimensional pattern;
b. a first electrode layer adjacent and conforming to said first electrolyte layer surface;
c. at least one mechanical support structure within some or all of said second set of features; and
d. a second electrode layer adjacent and conforming to said second electrolyte layer surface and to said at least one mechanical support structure.

2. A solid oxide fuel cell, comprising the membrane-electrode assembly of claim 1 deposited on a substrate with at least one through hole.

3. The solid oxide fuel cell as set forth in claim 2, wherein said second electrode layer covers some or all of the walls of said through hole.

4. The solid oxide fuel cell as set forth in claim 2, wherein said first and second electrode layers are porous electrode layers.

5. The solid oxide fuel cell as set forth in claim 2, wherein said substrate is a silicon wafer.

6. The solid oxide fuel cell as set forth in claim 2, wherein said hole is a cylindrical through hole.

7. The solid oxide fuel cell as set forth in claim 2, wherein said electrolyte layer is a dense ionic conducting oxide membrane with a thickness up to 200 nanometers.

8. The solid oxide fuel cell as set forth in claim 2, wherein said electrolyte layer is a composition-grading membrane having a varying dopant concentration from a predominant concentration of said electrolyte to a predominant concentration of said electrode.

9. The solid oxide fuel cell as set forth in claim 8, whereby said composition-grading membrane is fabricated using layer-by-layer deposition.

10. The solid oxide fuel cell as set forth in claim 2, wherein said electrode layers are porous electrode layers.

11. The solid oxide fuel cell as set forth in claim 2, wherein said electrode layers are composited with said electrolyte.

12. The solid oxide fuel cell as set forth in claim 2, wherein said electrode layers contain a metal catalyst.

13. The solid oxide fuel cell as set forth in claim 2, wherein said electrode layers have a thickness up to 200 nanometers.

14. The solid oxide fuel cell of claim 2, wherein said mechanical support layers are deposited to a top side and a bottom side of said substrate.

15. The solid oxide fuel cell as set forth in claim 2, wherein said layers and said structures are deposited using techniques comprising: DC/RF sputtering, chemical vapor deposition, pulsed laser deposition, molecular beam epitaxy, evaporation, and atomic layer deposition.

16. The solid oxide fuel cell as set forth in claim 2, wherein said fuel cell has a total thickness from 10 nanometers to 10 micrometers.

17. The thin film solid oxide fuel cell of claim 2, wherein boundaries between said electrolyte layer and said electrodes comprises a grain boundary formation.

18. A method of making a membrane-electrode assembly, comprising:
a. providing a mechanical support structure having opposite first and second mechanical support structure layer surfaces, wherein said mechanical support structure is arranged in a first three-dimensional pattern, wherein said first three-dimensional pattern having a first set of features extending inward from said first mechanical support structure layer surface, and a second set of features extending inward from said second mechanical support structure layer surface opposite to said first mechanical support structure layer surface of said first three-dimensional pattern;
b. depositing an electrolyte layer of substantially constant thickness to said mechanical support structure first layer surface and conforming with said mechanical support structure first three-dimensional pattern, wherein said electrolyte layer has opposite first and second electrolyte layer surfaces, wherein said electrolyte layer is arranged in a second three-dimensional pattern, wherein said second three-dimensional pattern has a first set of electrolyte features extending inward from said first electrolyte layer surface, and a second set of electrolyte features extending inward from said second electrolyte layer surface opposite to said first layer surface of said second three-dimensional pattern;
c. depositing a first electrode layer adjacent and conforming to said first electrolyte layer surface;
d. removing said first set of mechanical support structure features and a portion of said second mechanical support structure features, wherein a remaining portion of said second mechanical support structure features and said first set of electrolyte features are exposed to form a third three-dimensional pattern made from said first electrolyte features and said mechanical support structure; and
e. depositing a second electrode layer adjacent and conformal within said second electrolyte layer surface and with said remaining second mechanical support features.

19. A method of making a solid oxide fuel cell, wherein said membrane-electrode assembly of claim 18 is deposited on a substrate with a through hole.
